(19) United States
(12) Patent Application Publication
(10) Pub. No.: US 2004/0241396 A1
(43) Pub. Date: Dec. 2, 2004

(54) Method of modifying a surface of a substrate and articles therefrom

(75) Inventors: Naiyong Jing, Woodbury, MN (US); Caroline M. Ylitalo, Stillwater, MN (US); Gary A. Korba, Oakdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/448,229

(22) Filed: May 29, 2003

(51) Int. Cl. B41M 5/00

(52) U.S. Cl. 428/195.1

(57) ABSTRACT

A method of modifying a surface of a substrate comprises: inkjet printing a material, the material comprising a non-vaporizable component onto a surface of a substrate, wherein the non-vaporizable component comprises at least one compound having the formula

R_{f}—Z—X

wherein R_{f} is a perfluoroalkyl group having from 1 to 22 carbon atoms; Z is a divalent connecting group or a covalent bond; X is selected from the group consisting of —PO₃H, —CO₂H,

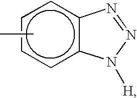

and salts thereof; and wherein the compound comprises greater than 10 percent by weight of the non-vaporizable component. Various articles may be produced according to the method.

### FIELD

The present invention relates to methods for modifying a surface of a substrate.

### BACKGROUND

Wetting behavior of a liquid on a substrate surface is typically a function of the surface energy of the substrate surface and the surface tension of the liquid. At the liquid-substrate surface interface, if the molecules of the liquid have a stronger attraction to the molecules of the substrate surface than to each other (the adhesive forces are stronger than the cohesive forces), then wetting of the substrate surface generally occurs. Alternatively, if the molecules of the liquid are more strongly attracted to each other than to the molecules of the substrate surface (the cohesive forces are stronger than the adhesive forces), then the liquid generally beads-up and does not wet the surface of the substrate.

One way to quantify surface wetting characteristics of a liquid on a surface of a substrate is to measure the contact angle of a drop of liquid placed on that surface. The contact angle is the angle formed by the solid/liquid interface and the liquid/vapor interface measured from the side of the liquid. Liquids typically wet surfaces when their contact angle is less than 90 degrees. Typically, a decrease in the contact angle between the liquid and the surface correlates with an increase in wetting. A zero contact angle generally corresponds to spontaneous spreading of the liquid on the surface of the substrate.

For many applications, the ability to precisely control the wetting of a liquid on a surface of a substrate according to a precise high-resolution pattern is important. Thus, it would be desirable to have additional methods and materials that can provide such control.

### SUMMARY

In one aspect, the present invention provides a method of modifying a surface of a substrate comprising inkjet printing a first material onto a portion of the surface of the substrate, wherein the material comprises a non-vaporizable component, wherein the non-vaporizable component comprises at least one compound having the formula

R_{f}—Z—X

wherein

R_{f} is a perfluoroalkyl group having from 1 to 22 carbon atoms;

Z is a divalent alkylene connecting group or a covalent bond; and

X is selected from the group consisting of —PO₃H, —CO₂H,

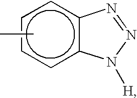

and salts thereof, and wherein the compound comprises greater than 10 percent by weight of the non-vaporizable component. In one embodiment, the first material further comprises a vaporizable liquid component.

In another aspect, the present invention provides an article comprising a substrate having a surface, the surface having a coating thereon, wherein the coating comprises an array of dots, wherein the array has a resolution in at least one dimension of at least 300 dots per inch, and wherein the coating comprises at least one compound having the formula

R_{f}—Z—X

wherein

R_{f} is a perfluoroalkyl group having from 1 to 22 carbon atoms;

Z is a divalent alkylene connecting group or a covalent bond; and

X is selected from the group consisting of —PO₃H, —CO₂H,

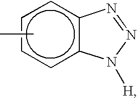

and salts thereof.

Methods according to the present invention are capable of providing high resolution patterns, and are typically well-suited for short run applications.

Further, methods according to the present invention may be well-suited for use with metallic substrates.

In this application:

all contact angles with water refer to determinations at 22° C., unless otherwise specified;

the term “vaporizable” means having a boiling point, at one atmosphere, of less than 160° C.;

the term “non-vaporizable” refers to any compound that is not “vaporizable”; and

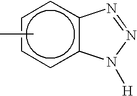

refers to a monovalent benzotriazole group wherein the valence may be at any of the aryl carbon atoms.

### DETAILED DESCRIPTION

In practice of the present invention a first material comprising surface of a first material comprising a non-vaporizable component and, optionally, a vaporizable liquid component and is inkjet printed onto a portion of a surface of a substrate.

The non-vaporizable component comprises a self-assembling compound having the formula

R_{f}—Z—X

wherein

R_{f} is a perfluoroalkyl group having from 1 to 22 carbon atoms;

Z is a divalent connecting group or a covalent bond; and

X is selected from the group consisting of —PO₃H, CO₂H,

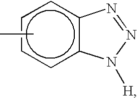

and salts thereof.

Useful perfluoroalkyl groups R_{f} include linear perfluoroalkyl groups (e.g., perfluoromethyl, perfluoropropyl, perfluorohexyl, perfluorooctyl, perfluorodecyl, perfluorohexadecyl, and perfluoroeicosyl) and branched perfluoroalkyl groups (e.g., perfluoroisopropyl, perfluoroisooctyl, and perfluoro(1,1,2-trimethylpentyl)).

Useful divalent connecting groups include, for example, a covalent bond; an organic group such as linear or branched divalent alkylene having from 1 to 22 carbon atoms (e.g., methylene, ethylene, propylene, decylene) or divalent arylene having from 6 to 10 carbon atoms; divalent aromatic hydrocarbons (e.g., phenylene); sulfur; oxygen; alkylimino (e.g., —NR—, wherein R is a lower alkyl group); carbonyl; carbonyloxy; carbonylamino; carbonyldioxy; sulfonyl; sulfonyloxy; sulfonamido; carbonamido; sulfonamidoalkylene (e.g., —SO₂NR₁(CH₂)ₓ—, wherein x is 1 to 6 and R₁ is lower alkyl having 1 to 4 carbon atoms); carbonamidoalkylene; carbonyloxy; ureylene; and combinations thereof. Other divalent connecting groups may also be used. In some embodiments, Z may be selected to be free of active hydrogen atoms (e.g., hydroxyl or acidic hydrogen atoms) or other hydrophilic groups, as these may tend to reduce the advancing contact angle with water of coatings prepared from such materials. In some embodiments, Z may be relatively small (e.g., having less than 20 atoms in the backbone connecting R_{f} and X).

Useful X groups include —PO₃H, —CO₂H,

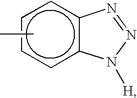

and salts thereof. Exemplary useful salts include alkali metal salts (e.g. sodium, lithium, and potassium salts), ammonium salts and derivatives thereof (e.g., ammonium, alkylammonium, and quaternary ammonium salts), and quaternary phosphonium salts (e.g., tetramethylphosphonium and phenyltributylphosphonium salts).

In some cases, it may be desirable to select R_{f} and Z such that, taken together, R_{f} and Z comprise at least 7 carbon atoms.

Self-assembling compounds that are useful in practice of the present invention may be prepared according to a variety of methods. For example, perfluoroalkyl iodides may be coupled to carboxylic acids, phosphonic acids, or benzotriazoles having terminal olefinic substituents, and the iodine subsequently removed with zinc, according to the general approach shown in the examples. Further details concerning methods for preparing SAMs useful in practice of the present invention may be found, for example, in U.S. Pat. No. 6,376,065 (Korba et al.), and in commonly assigned co-pending U.S. application Ser. Nos. 10/161,258 (Boardman et al., filed May 31, 2002) and 09/664,687 (Pellerite et al., filed Sep. 19, 2000), the disclosures of which are incorporated herein by reference.

The non-vaporizable component may further comprise additional non-vaporizable compounds, such as for example, non-vaporizable fluid materials (e.g., high boiling solvents) and other additives. In contrast to inkjet printing of typical fluorinated materials, self-assembling compounds used in practice of the present invention may have high affinity for certain substrates (e.g., depending on the nature of X group). Thus, inkjet printing and subsequent rinsing with solvent may be an effective way of applying the self-assembling compound to the substrate surface such that it is effectively bound to the surface.

In order to achieve useful wetting properties after printing, the self-assembling compound comprises at least 10, 20, 30, 40, or even at least 50 percent by weight up to and including 100 percent by weight of the non-vaporizable component. Similarly, the non-vaporizable component may comprise from 0.001, 0.01, 0.1, or 1 percent by weight up to 5, 10, 20, 30, 40, 50, or even up to and including 100 percent by weight, based on the total weight of the first material. For example, the non-vaporizable component may comprise from 0.01 up to and including 100 percent by weight of the first material.

Typically, the self-assembling material should be applied in sufficient quantity to achieve at least a monolayer coverage of the substrate surface where printed, although less than a monolayer coverage of the surface may also be used. Monolayer coverage may be achieved, for example, by printing in a single pass or in multiple passes as desired.

In another embodiment, a vaporizable component such as for example a solvent or a solvent mixture may be combined with the non-vaporizable component to form a solution or dispersion. In this embodiment, the composition may be precisely printed onto the substrate and thereafter isolated by removal of the vaporizable component (e.g., by evaporation, including evaporation at reduced pressure). Useful solvents include nonfluorinated organic and inorganic solvents (e.g., alcohols and water) and fluorinated organic solvents. Due to the high cost of fluorinated organic solvents, it may be desirable that the vaporizable liquid component comprise at least one non-fluorinated vaporizable organic liquid, or even consist essentially (i.e., be free of within ordinary manufacturing tolerances) of non-fluorinated vaporizable organic liquid. The relative amount of any vaporizable component typically depends, on the desired concentration

The first material may optionally contain additives such as, for example, dyes, thickeners, fragrances, and the like. The amount of any such additives should typically be kept at a level that will not seriously adversely impact the wetting behavior of the inkjet printed surface of the substrate.

Typically, any solid substrate may be used in practice of the present invention. For example, useful substrates may be opaque, translucent, clear, textured, patterned, rough, smooth, rigid, flexible, treated, primed, or a combination thereof. The substrate typically comprises organic and/or inorganic material. The substrate may be, for example, thermoplastic, thermoset, or a combination thereof. Exemplary substrates include films, plates, tapes, rolls, molds, sheets, blocks, molded articles, fabrics, and fiber composites (e.g., circuit boards), and may comprise at least one organic polymer such as polyimide, polyester, acrylic, polyurethane, polyether, polyolefin (e.g., polyethylene or polypropylene), polyamide, and combinations thereof. Exemplary inorganic substrates include metals (e.g., chromium, aluminum, copper, nickel, silver, gold, and alloys thereof), ceramics, glass, china, quartz, polysilicon, and combinations thereof.

Exemplary inkjet printing methods include thermal inkjet, continuous inkjet, piezo inkjet, acoustic inkjet, and hot melt inkjet printing. Thermal inkjet printers and/or print heads are readily commercially available, for example, from Hewlett-Packard Corporation (Palo Alto, Calif.), and Lexmark International (Lexington, Ky.). Continuous inkjet print heads are commercially available, for example, from continuous printer manufacturers such as Domino Printing Sciences (Cambridge, United Kingdom). Piezo inkjet print heads are commercially available, for example, from Trident International (Brookfield, Conn.), Epson (Torrance, Calif.), Hitachi Data Systems Corporation (Santa Clara, Calif.), Xaar PLC (Cambridge, United Kingdom), Spectra (Lebanon, N.H.), and Idanit Technologies, Limited (Rishon Le Zion, Israel). Hot melt inkjet printers are commercially available, for example, from Xerox Corporation (Stamford, Conn.).

Techniques and formulation guidelines for inkjet printing are well known (see, for example, “Kirk-Othmer Encyclopedia of Chemical Technology”, Fourth Edition (1996), volume 20, John Wiley and Sons, New York, pages 112-117), and are within the capability of one of ordinary skill in the art. For example, inkjet printable compositions are commonly formulated to have a viscosity of less than or equal to 35 millipascal-seconds at the intended jetting temperature.

The first material may be applied to any portion of the surface of the substrate by various techniques including, for example, moving the substrate relative to a fixed print head, or by moving the print head relative to a fixed or movable substrate.

The first material is typically inkjet printed in a predetermined pattern (although random patterns may be used) as a coating onto a surface of the substrate. The coating may comprise an array of dots, which depending on the wetting ability and the number of printing passes may coalesce, remain separated, or a combination thereof. Depending on the resolution of the inkjet printer, the array may have a resolution in at least one dimension of at least 300 dots per inch (i.e., dpi) (120 dots/cm), 600 dpi (240 dots/cm), 900 dpi (350 dots/cm), or even at least 1200 dpi (470 dots/cm). Exemplary patterns include lines (e.g., straight, curved, or bent lines) that may, for example, form a geometric outline such as a polygon or an ellipse.

In some embodiments according to the present invention, the substrate can be chemically modified after inkjet printing the first material onto the surface of the substrate, and subsequently removing of any optional vaporizable liquid component (e.g., by evaporation). Exemplary methods of chemical modification include etching (e.g., acid etching and plasma etching).

Methods according to the present invention have utility in the manufacture of a variety of articles, including, for example, microfluidic devices (e.g., lab on a chip and drug delivery devices), analytical test strips (e.g., blood glucose test strips).

Articles prepared according to the present invention may be used by themselves, or in combination with a second material (typically a fluid). In such instances, the second material is typically brought into contact with at least one of the coated first material and the substrate surface. Exemplary second materials include water and biological fluids (e.g., serum, uirine, saliva, tears, and blood) and molten organic polymers (i.e., thermoplastic s).

Objects and advantages of this invention are further illustrated by the following non-limiting examples, but the particular materials and amounts thereof recited in these examples, as well as other conditions and details, should not be construed to unduly limit this invention.

### EXAMPLES

Unless otherwise noted, all reagents used in the examples were obtained, or are available, from general chemical suppliers such as Aldrich Chemical Company, Milwaukee, Wis., or may be synthesized by known methods.

In the following examples, inkjet printing was performed as follows: the indicated solution was inkjet printed onto the indicated substrate using a piezo inkjet print head obtained under the trade designation “XJ128-200” from Xaar, PLC (Cambridge, United Kingdom). The print head was mounted in fixed position, and the substrate was mounted on an x-y translatable stage, which was moved relative to the print head while maintaining a constant distance between the print head and the stage. Printing resolution was 317×295 dots per inch (125×116 dots per cm) with a nominal drop volume of 70 picoliters.

In the following examples, contact angles were measured using deionized water and a contact angle measurement apparatus obtained under the trade designation “VCA 2500XE VIDEO CONTACT ANGLE MEASURING SYSTEM” from AST Products (Billerica, Mass.).

Preparation of C₄F₉CH₂CHI(CH₂)₈CO₂H

Into a 250 mL flask was placed 11 g undecylenic acid, a solution of 6.0 g sodium bicarbonate in 100 ml of water, and 21 g n-perfluorobutyl iodide. The mixture was stirred by means of a high-shear stirrer at room temperature. To the mixture was slowly introduced 11 g sodium dithionite. Foaming and evolution of heat were observed immediately. After addition was complete, the mixture was stiffed for 10 minutes at room temperature, and then poured into a beaker containing 150 mL of water and subsequently acidified with hydrochloric acid. An oily phase formed which was separated from the aqueous phase and analyzed by gas chromatography to be 90 percent conversion to C₄F₉CH₂CHI(CH₂)₈CO₂H based on consumption of the perfluorobutyl iodide. The entire procedure was repeated and the products combined before proceeding.

Into a three-necked flask equipped with a condenser, thermometer, and stirrer was placed 15 g zinc powder, 100 mL of ethanol, and a catalytic amount of acetic acid. To the stirred mixture was added 5 g of C₄F₉CH₂CHI(CH₂)₈CO₂H. After a 20-minute induction period, the reaction started and gave off heat. Subsequently, an additional 50 g C₄F₉CH₂CHI(CH₂)₈CO₂H was introduced gradually while maintaining a temperature in a range of 50-60° C. After addition was complete, the reaction mixture was stirred overnight at room temperature. The reaction mixture was then poured into a beaker containing 250 mL of water. The aqueous solution was extracted with three 150 mL portions of ether. The ether extracts were combined, dried over anhydrous magnesium sulfate, and filtered. The ether was removed to give a white solid, which was further purified by recrystallization from methylene chloride to give 33.5 g of C₄F₉(CH₂)₁₀CO₂H.

Preparation of 11-(perfluorobutyl)undecanephosphonic acid (C₄F₉(CH₂)₁₀CH₂PO₃H):

Into a 250 mL flask equipped with a condenser, thermometer, and stirrer was placed 27 g undecylenyl alcohol, 55 g perfluorobutyl iodide, 80 mL of acetonitrile and 80 mL of water. The mixture was stirred at room temperature, and to the mixture was slowly introduced a solid mixture of 27 g sodium dithionite and 15 g sodium bicarbonate. The mixture immediately started to foam and give off heat. After addition was complete, the mixture was stirred at room temperature overnight, then poured into a beaker containing 300 mL of water, and subsequently acidified with hydrochloric acid. The mixture was extracted with three 150 mL portions of ether. The ether extracts were combined and dried over anhydrous magnesium sulfate. The ether was removed to give 74 g C₄F₉CH₂CHI(CH₂)₈CH₂OH as a viscous liquid.

Into a three-necked flask was placed 30 g zinc powder, 100 mL of ethanol, and a catalytic amount of acetic acid. The mixture was stirred and 5 g of C₄F₉CH₂CHI(CH₂)₈CH₂OH was added. After a 20-minute induction period, evolution of heat was observed. Subsequently, 69 g C₄F₉CH₂CHI(CH₂)₈CH₂OH was introduced gradually while maintaining a temperature in a range of 50-60° C. After addition was complete, the mixture was stirred overnight at room temperature. The reaction mixture was then poured into a beaker containing 250 mL of water. The aqueous solution was extracted with three 150 mL portions of ether. The ether extracts were combined and dried over anhydrous magnesium sulfate. After filtration, the ether was removed to give a white solid, which was further purified by recrystallization from methylene chloride to give C₄F₉(CH₂)₁₀CH₂OH in 85 percent yield.

To a mixture of 9.8 g of C₄F₉(CH₂)₁₀CH₂OH and 110 mL of 48 percent hydrobromic acid was slowly added 12 mL of concentrated sulfuric acid. The reaction mixture was heated 100° C. overnight, and the reaction mixture was poured into 500 mL of water. The mixture was extracted with hexanes, and the extract was washed with saturated aqueous sodium bicarbonate, and dried over anhydrous magnesium sulfate. After filtration, the solution was concentrated to an amber liquid, which was eluted through 3 inches (8 cm) of silica gel using hexanes. Concentration of the eluent yielded a light amber liquid, and bulb to bulb distillation gave 9.5 g of C₄F₉(CH₂)₁₀CH₂Br as a clear, colorless liquid.

A mixture of 9.5 g of C₄F₉(CH₂)₁₀CH₂Br and 9 g of triethyl phosphite was heated at 150° C. overnight. An additional 5 g of triethyl phosphite was added and heating was continued for 24 hours longer. Vaporizable materials were removed by evaporation under reduced pressure, and bulb to bulb distillation of the concentrate provided 9.0 g of C₄F₉(CH₂)₁₀CH₂PO(OCH₂CH₃) as a clear, colorless liquid.

To a solution of 9 g of C₄F₉(CH₂)₁₀CH₂PO₃H₂ in 30 mL of methylene chloride was added 7 g of bromotrimethylsilane. The mixture was stirred overnight at room temperature while exposed to ambient humidity, and then the solution was concentrated to give a pale yellowish liquid, which was dissolved in 110 mL of methanol. The solution was stirred at room temperature for 30 minutes and then concentrated to give a white solid, the solid was recrystallized from heptane to give 7.1 g of C₄F₉(CH₂)₁₀CH₂PO₃H2.

Preparation of 1H,1H,2H,2H-perfluorodecyl benzotriazole-5-carboxylic acid ester:

1H,1H,2H,2H-perfluorodecyl benzotriazole-5-carboxylic acid ester was prepared according to the procedure of Example 3 of U.S. Pat. No. 6,376,065 (Korba et al.)

### Example 1

A 1 percent by weight solution of 11-(perfluorobutyl)undecanoic acid in methanol was inkjet printed onto silver foil (0.125mm thick, 99.8% pure obtained from Aldrich Chemical Company). Measured contact angles with deionized water on the printed area of the substrate at 22° C. (static/advancing/receding) were 107/113/68 degrees, respectively.

### Example 2

A 0.5 percent by weight solution of 11-(perfluorobutyl)undecanephosphonic acid in ethanol was inkjet printed onto copper foil (50 mm×50 mm×1.0 mm, 99.88% purity, obtained from Aldrich Chemical Company). Measured contact angles with deionized water on the printed area of the substrate at 22° C. (static/advancing/receding) were 128/134/102 degrees, respectively.

### Example 3

A 0.5 percent by weight solution of 11-(perfluorobutyl)undecanephosphonic acid in ethanol was inkjet printed onto nickel foil (50 mm×50 mm×0.125 mm, 99.9% purity, obtained from Aldrich Chemical Company). Measured contact angles with deionized water on the printed area of the substrate at 22° C. (static/advancing/receding) were 128/134/102 degrees, respectively.

### Example 4

A 0.1 percent by weight solution of 1H,1H,2H,2H-perfluorodecyl benzotriazole-5-carboxylic acid ester in ethyl acetate was inkjet printed onto copper foil (50 mm×50 mm×1.0 mm, 99.88% purity, obtained from Aldrich Chemical Company). Measured contact angles with deionized water on the printed area of the substrate at 22° C. (static/advancing/receding) were 132/137/112 degrees, respectively.

### Example 5

A 0.1 percent by weight solution of 1H,1H,2H,2H-perfluorodecyl benzotriazole-5-carboxylic acid ester in ethyl acetate was inkjet printed onto nickel foil (50 mm×50 mm×0.125 mm, 99.9% purity, obtained from Aldrich Chemical Company). Measured contact angles with deionized water on the printed area of the substrate at 22° C. (static/advancing/receding) were 132/137/112 degrees, respectively.

Various unforeseeable modifications and alterations of this invention may be made by those skilled in the art without departing from the scope and spirit of this invention, and it should be understood that this invention is not to be unduly limited to the illustrative embodiments set forth herein.

What is claimed is:

1. A method of modifying a surface of a substrate comprising inkjet printing a first material onto a portion of the surface of the substrate, wherein the material comprises a non-vaporizable component, wherein the non-vaporizable component comprises at least one compound having the formula
R_{f}—Z—X
wherein
R_{f} is a perfluoroalkyl group having from 1 to 22 carbon atoms;
Z is a divalent connecting group or a covalent bond; and
X is selected from the group consisting of —PO₃H, —CO₂H, 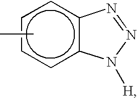
and salts thereof, and wherein the compound comprises greater than 10 percent by weight of the non-vaporizable component.

2. A method according to claim 1, wherein the first material further comprises a vaporizable liquid component.

3. A method according to claim 1, wherein Z is selected from the group consisting of divalent alkylene having from 1 to 22 carbon atoms, divalent arylene having from 6 to 10 carbon atoms, oxygen, sulfur, carbonyl, carbonyloxy, carbonylamino, carbonyldioxy, sulfonyl, sulfonyloxy, alkylimino, sulfonamido, ureylene, and combinations thereof.

4. A method according to claim 1, wherein the compound comprises greater than 30 percent by weight of the non-vaporizable component.

5. A method according to claim 1, wherein the compound comprises greater than 50 percent by weight of the non-vaporizable component.

6. A method according to claim 1, wherein the compound comprises greater than 70 percent by weight of the non-vaporizable component.

7. A method according to claim 1, wherein the compound comprises greater than 90 percent by weight of the non-vaporizable component.

8. A method according to claim 1, wherein the substrate is metallic.

9. A method according to claim 1, wherein the substrate comprises one or more metals selected from the group consisting of chromium, aluminum, copper, nickel, and silver, gold, and alloys thereof.

10. A method according to claim 1, wherein the substrate comprises ceramic, glass, china, polysilicon, quartz, or a combination thereof.

11. A method according to claim 2, further comprising removing at least a portion of the vaporizable liquid component.

12. A method according to claim 1, wherein the material is applied to the surface of the substrate according to a predetermined pattern.

13. A method according to claim 1, wherein the substrate comprises a metal roll.

14. A method according to claim 2, wherein the vaporizable liquid component comprises at least one nonfluorinated vaporizable organic liquid.

15. A method according to claim 2, wherein the vaporizable liquid component consists essentially of nonfluorinated vaporizable organic liquid.

16. A method according to claim 1, further comprising modifying at least a portion of the surface of the substrate.

17. A method according to claim 16, wherein modifying comprises at least one of etching or rinsing.

18. A method according to claim 1, wherein inkjet printing comprises piezo inkjet printing.

19. A method according to claim 1, wherein the substrate comprises organic polymer.

20. A method according to claim 19, wherein organic polymer comprises polyester, polyimide, polyamide, acrylic, polyether, polyolefin, or a combination thereof.

21. A method according to claim 1, further comprising applying a second material to the substrate surface.

22. A method according to claim 21, wherein the second material comprises water.

23. A method according to claim 21, wherein the second material comprises a biological fluid.

24. A method according to claim 21, wherein the second material comprises molten organic polymer.

25. An article comprising a substrate having a surface, the surface having a coating thereon, wherein the coating comprises an array of dots, wherein the array has a resolution in at least one dimension of at least 300 dots per inch, and wherein the coating comprises at least one compound having the formula
R_{f}—Z—X
wherein
R_{f} is a perfluoroalkyl group having from 1 to 22 carbon atoms;
Z is a divalent connecting group or a covalent bond; and
X is selected from the group consisting of —PO₃H, —CO₂H, 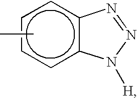
and salts thereof.

26. An article according to claim 25, wherein Z is selected from the group consisting of divalent alkylene having from 1 to 22 carbon atoms, divalent arylene having from 6 to 10 carbon atoms, oxygen, sulfur, carbonyl, carbonyloxy, carbonylamino, carbonyldioxy, sulfonyl, sulfonyloxy, alkylimino, sulfonamido, ureylene, and combinations thereof.

27. An article according to claim 25, wherein the substrate is metallic.

28. An article according to claim 25, wherein the substrate comprises one or more metals selected from the group consisting of chromium, aluminum, copper, nickel, and silver, gold, and alloys thereof.

29. An article according to claim 25, wherein the substrate comprises ceramic, glass, china, polysilicon, quartz, or a combination thereof.

30. An article according to claim 25, wherein the substrate comprises organic polymer.

31. An article according to claim 30, wherein organic polymer comprises polyester, polyimide, polyamide, acrylic, polyether, polyolefin, or a combination thereof.
